(19) United States
(12) Patent Application Publication
(10) Pub. No.: US 2007/0226210 A1
(43) Pub. Date: Sep. 27, 2007

(54) Automatic user defaults

(76) Inventor: Wolfgang E. Walter, Hambrucken (DE)

Correspondence Address: SAP/BLAKELY, 1279 OAKMEAD PARKWAY, SUNNYVALE, CA, 94085-4040, US

(21) Appl. No.: 11/388,468

(22) Filed: Mar. 24, 2006

(51) Int. Cl. G06F 17/30

(52) U.S. Cl. 707/6

(57) ABSTRACT

A method and system for maintaining and supplying user defaults during transactions. Upon initiation of a transaction, a determination is made if any mandatory values are not maintained or if an explicit request is received. Values supplied in the window are verified to determine that they satisfy requirements of the expected values. If the verification fails, the transaction is prevented from continuing. Otherwise, the supplied values are maintained in persistent storage. Those values are then made available elsewhere in the transaction without requiring reentry.

### BACKGROUND OF THE INVENTION

1. Field

Embodiments of the invention relate to transaction processing. More specifically, embodiments of the invention relate to maintaining and supplying required values automatically.

2. Background

In the context of transaction processing, various mandatory values are often reused in many cases requiring reentry of the value by a user. This reentry is both inconvenient and can lead to data entry errors. Often these features never change or change very infrequently. To address these issues, some systems use variants. Variants are associated with selection screens in a particular program and display a set of input fields for database specific and program specific selections. A user can fill the input fields of the variant and subsequently need not reenter the supplied values at those selection screens. While variants are useful in that they eliminate the need to continually reenter identical values for the selection screen, they fail to make values available elsewhere in the transaction. Additionally, variants are not created on a per user basis. Accordingly, it is not possible to create defaults that can be applied on a per user basis throughout a transaction using variants.

### SUMMARY OF THE INVENTION

A method and system for maintaining and supplying user defaults during transactions is disclosed. Upon initiation of a transaction, a determination is made if any mandatory values have been previously maintained. A window to accept mandatory values is generated only if either the mandatory values are not maintained or if an explicit request to change maintained values is received. Values supplied in the window are verified to determine that they satisfy requirements of the expected values. If the verification fails, the transaction is prevented from continuing. Otherwise, the supplied values are maintained in persistent storage. Those values are then made available elsewhere in the transaction without requiring reentry.

### BRIEF DESCRIPTION OF DRAWINGS

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is as flow diagram of operation in one embodiment of the invention.

FIG. 2 is a block diagram of one embodiment of the invention.

### DETAILED DESCRIPTION

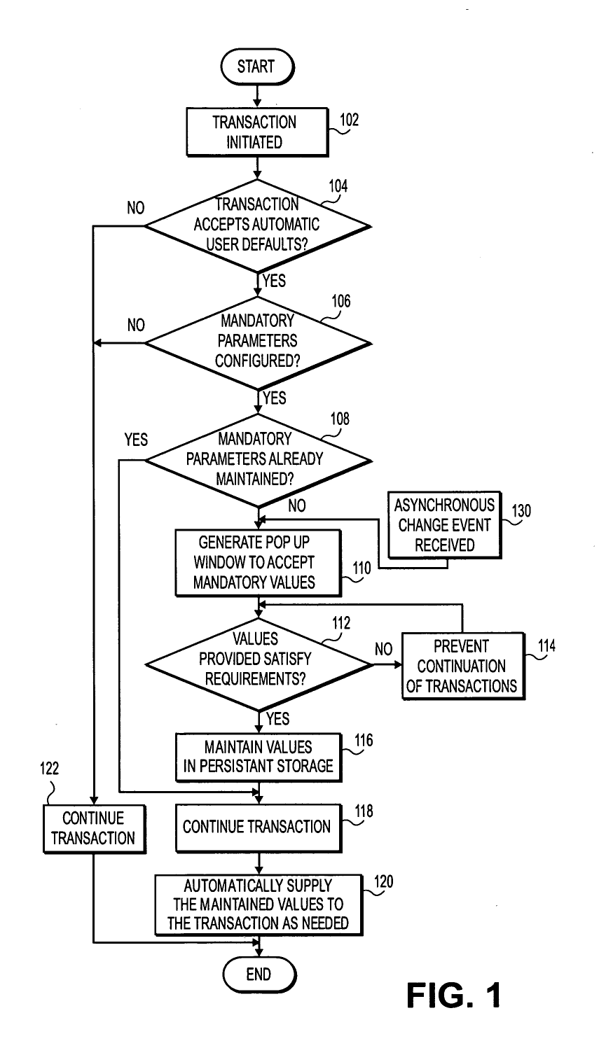

FIG. 1 is as flow diagram of operation in one embodiment of the invention. At block 102, a transaction is initiated. For example, the transaction may be a warehouse transaction in an extended warehouse management system, available from SAP AG of Waldorf, Germany. Alternatively, other transactions, such as inbound or outbound deliveries or other types of business transactions may be initiated. Once initiated, a determination is made at block 104 if the transaction accepts automatic user defaults. If not, the transaction continues at block 122.

If the transaction accepts automatic user defaults, a determination is made at block 106 whether any mandatory parameters have been configured for this transaction. For example, warehouse management transactions may have warehouse number as a mandatory parameter. A physical inventory transaction may have warehouse number and year as mandatory parameters. Numerous other possible examples exist. If no mandatory parameter are configured, the transaction continues at block 122.

If some parameters for the transaction are configured as mandatory, a determination is made at block 108 if the mandatory parameters have already been maintained by the user initiating the transaction. If the parameters have not been maintained, a pop up window is generated to accept the mandatory values at block 110. Once a user provides values via the pop up window, a determination is made at block 112 if the values satisfy the requirements of the expected values. In one embodiment, this verification may constitute merely a semantic check to make sure that the value provided is of the right type, e.g., character, integer, string, etc., or format, e.g., correct length, etc. In another embodiment, satisfaction of the requirements is determined by a strict comparison between the value entered and a subset of the possible acceptable values until a match is found.

If the values provided fail to satisfy the requirements for the expected mandatory values (either semantically or alternatively exact matching), the transaction is prevented from continuing at block 114. In one embodiment, preventing continuation is effected by maintaining the pop up window as the focal window until either acceptable values are provided or the transaction is cancelled. In some embodiment, an error message may also be presented to the user identifying what values have failed to satisfy the requirements and possibly why the requirements are not satisfied, e.g., “numeric value expected.”

If the values are determined to satisfy the requirements at block 112, the values are maintained in persistent storage at block 116. In one embodiment, the values may be maintained in the database. In another embodiment, they may be maintained in a file system. In one embodiment, the values are maintained in the database in a database table having the user identification as a key into the database table. This permits the defaults to be maintained on a per user basis and to be valid at any point within the transaction. As such, the variant requirement of association with a selection screen and the inability to create per user defaults are eliminated.

In some embodiments, the defaults can be maintained across different transaction types, as well as different transactions. In such an embodiment, the e.g., database table, may include flags indicating the transactions for which the maintained values are valid. Other ways of identifying the transactions for which the maintained values are valid are also within the scope and configuration of the invention.

At block 118, the transaction is allowed to continue. If at decision block 108 the parameters were already maintained, the transaction similarly continues at block 118. In this manner, the pop up window only occurs once on the first run of the transaction or, in the event that the user seeks to change the default values an asynchronous change event received at block 130 will trigger the generation of a pop up window at block 110 to permit the values to be changed. In one embodiment, the asynchronous change event may be the key stroke or key sequence entered by a user, for example the F4 key. In this way, the user can easily change the maintained values at any time. The underlying system insures proper notification to all interested parties once a change occurs. At block 120, the maintained values are automatically supplied to the transaction as needed.

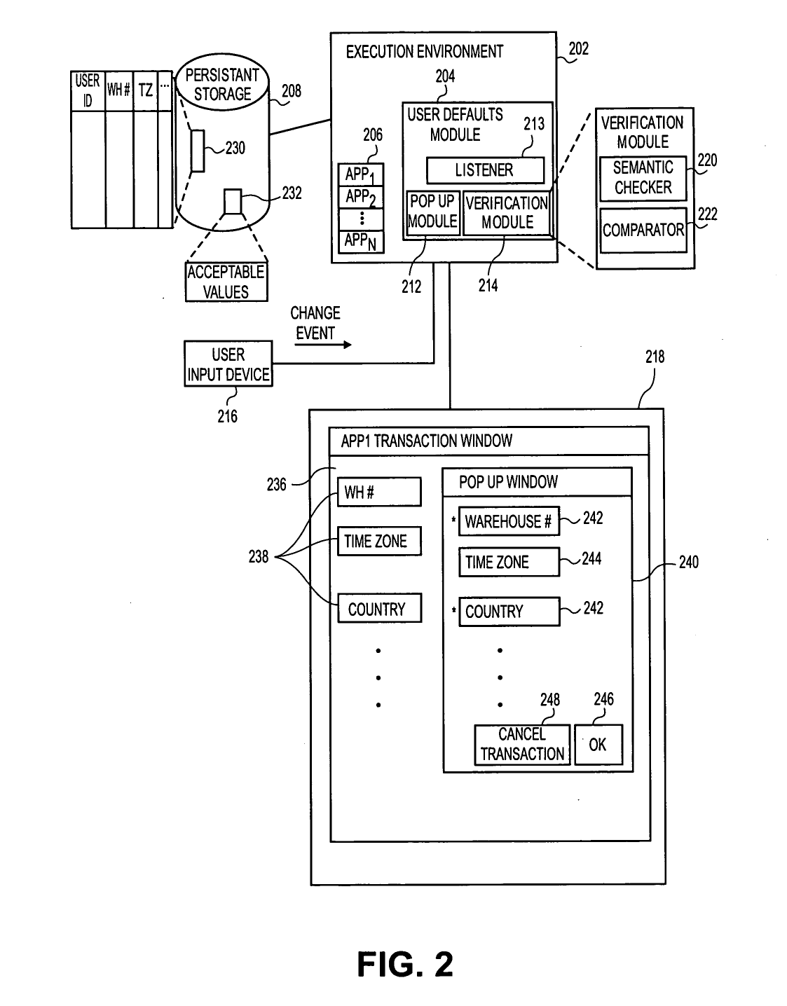

FIG. 2 is a block diagram of one embodiment of the invention. An execution environment 202 is coupled to a persistent store 208. In one embodiment, the execution environment may be a virtual machine. In another embodiment, execution environment 202 may be instantiated as a physical processor. On execution environment 202, a plurality of applications 206 exist that may execute within the environment. Also instantiated as either hardware or software components within the execution environment 202 is a user default module 204 including a listener 213, a pop up module 212, and a verification module 214. A verification module 214 may include one or both of a semantic checker 220 and/or a comparator 222. In one embodiment, the user defaults module may be implemented as a service within a global class. This renders the service available as a public static method without requiring any class instantiation.

Persistent storage 208 may be, in one embodiment, a database, such as a SQL database widely available in the industry. In another embodiment, persistent storage may be a file system for the execution environment. Persistent storage 208 may maintain a database table 230 holding previously maintained values indexed by a user identifier. Persistent 208 may also include a data structure 232 holding acceptable values for one or more of the mandatory parameters that may be maintained.

A user input device 216 is coupled to the execution environment 212. In one embodiment, user input device 216 may be a keyboard that may be used to send a change event to the execution environment 202. Alternative user input devices such as, pointing devices, audio interfaces, etc., may be used. Listener 213 listens for the change event and invokes the pop up module 212 responsive to receipt of a change event.

A display 218 is also coupled via the execution environment 202 and may display a graphical user interface of transaction window 236 having a plurality of fields 238 to receive values pertinent to the transaction. Upon entry of the first occurrence of the transaction invoked by the user or responsive to receipt of the change event in execution environment 202, pop up module 212 causes the generation of pop up window 240 within display 218. In one embodiment, pop up window 240 remains the focal window within the user interface until acceptable values have been provided for all mandatory values 242 or the transaction has been cancelled. By focal window, it is meant: the topmost window in the display and the only window in which actions can be taken.

In this example, mandatory values 242 are denoted by an asterisk and optional values 244 may also be present. Thus, the user may elect to maintain both mandatory and optional values, but is required to supply mandatory values. In this example, warehouse, number and country are designated as a mandatory values 242 and time zone is designated as an optional value 244. It should be recognized that these are merely examples of mandatory and optional values, more, fewer, and different mandatory/optional values are within the discretion of the developer of the underlying application that performs the transaction.

Also provided are soft buttons 248 to cancel the transaction and 246 to maintain the value entered. In one embodiment, responsive to actuation of the OK soft button 246, verification module 214 performs it verification whether it be semantically checking each of the mandatory fields to insure that they follow the correct semantics or performing an actual comparison between the acceptable values 232 both particular mandatory field and value entered using comparator 222. In an alternative, embodiment verification of a field value occurs when a user attempts to exit the field. In some embodiments, pop up module may generate a pop up window with e.g., pull down menus associated one or more mandatory fields. In such an embodiment, selection from the menu provides implicit verification that the value meets requirements. In some embodiments, the menus are populated at run time from the acceptable values data structure 232 in the persistent store 208. If the mandatory values are deemed acceptable from explicit on implicit verification, they can then be maintained in the database table 230. Pop up window will then vanish and the transaction window with the maintained values filled in again becomes the focal window. The maintained values are available for use down stream within the transaction as well as subsequent transactions of the same type. Because the pop up window does not recur smoother transaction processing is possible. In some embodiments, the maintained values can also be used for other transaction types. From the perspective of the transaction developer, the validity of the values is assured without requesting verification each time a value is used within a transaction.

While embodiments of the invention are discussed above in the context of flow diagrams reflecting a particular linear order, this is for convenience only. In some cases, various operations may be performed in a different order than shown or various operations may occur in parallel. It should also be recognized that some operations described with respect to one embodiment may be advantageously incorporated into another embodiment. Such incorporation is expressly contemplated.

Elements of embodiments may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or other type of machine-readable media suitable for storing electronic instructions. For example, embodiments of the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method comprising:
determining if a mandatory value is maintained in a persistent store when a transaction begins;
generating a window to accept the mandatory value only if not retained in the persistent store or an explicit request is received;
verifying that a value provided satisfies a requirement for the mandatory value;
preventing the continuation of the transaction if the requirement is not met;
maintaining the value in the persistent store if the requirement is met; and
making the value available at another point in the transaction.

2. The method of claim 1 further comprising:
using the value in a second transaction type different from the transaction.

3. The method of claim 1 wherein verifying comprises:
confirming the value is semantically correct.

4. The method of claim 1 wherein checking comprises:
comparing the value with at least a subset of valid values until a match is found.

5. The method of claim 4 wherein verifying further comprises:
rejecting the value unless a match is found.

6. The method of claim 1 wherein making the value available comprises:
permitting user access to the value in the database at any point during the transaction.

7. The method of claim 6 wherein permitting comprises:
automatically populating a field of a user interface display that corresponds to the value.

8. The method of claim 1 wherein preventing comprises:
maintaining the pop up as a focal window until the value is provided or the transaction is canceled.

9. The method of claim 1 further comprising:
displaying a pop up window to accept a changed value in response to a triggering event; and
replacing the value maintained in the database with the changed value.

10. A system comprising:
a persistent storage unit:
a user default module to ensure a value for at least one value is maintained in the persistent storage unit, the user default module having a pop up generation module and verification module; and
application to conduct a transaction using the value.

11. The system of claim 10 further comprising:
a graphical user interface (GUI) responsive to the pop up module to display modifiable fields corresponding to the at least one value.

12. The system of claim 10 wherein the user default module comprises:
a listener to invoke the pop up generation module responsive to an external event.

13. The system of claim 10 wherein the verification module comprises:
a comparator to compare at least a subset valid values with a value provided from the persistent storage.

14. The system of claim 10 further comprising:
a database table in the persistent storage to be populated with data provided to the user default module and to be indexed by a user identifier.

15. A machine-accessible medium containing instructions that when executed cause a machine to:
determine if a mandatory value is maintained in a persistent store when a transaction begins;
generate a window to accept the mandatory value if not retained in the persistent store;
verify that a value provided satisfies a requirement for the mandatory value;
prevent the continuation of the transaction if the requirement is not met;
maintain the value in the persistent store if the requirement is met; and
make the value available at another point in the transaction.

16. The machine accessible median of claim 15, further comprising instructions causing the machine to:
use the value in a second transaction type different from the transaction.

17. The machine accessible median of claim 15, wherein the instructions causing the machine to verify cause the machine to:
confirm the value with at least a subset of valid values until a match is found.

18. The machine accessible median of claim 17, wherein the instructions causing the machine to check further cause the machine to:
reject the value unless a match is found.

19. The machine accessible median of claim 15, wherein the instructions causing the machine to make the value available cause the machine to:
permit user access to the value in the database at any point during the transaction.

20. The machine accessible median of claim 19, wherein the instructions causing the machine to permit user access cause the machine to:
automatically populate a field of a user interface display that corresponds to the value.

21. The machine accessible median of claim 15, further comprising instructions causing the machine to:
display a pop up window to accept a change value in response to a triggering event; and
replace the value maintained in the database with the change value.
